(19) United States
(12) Patent Application Publication
(10) Pub. No.: US 2002/0035906 A1
(43) Pub. Date: Mar. 28, 2002

(54) High-speed shear for transversely cutting rolled strip

(76) Inventors: Dieter Rosenthal, Niederfischbach (DE); Friedhelm Kalteich, Freudenberg (DE); Martin Braun, Kreuztal (DE); Karl-Friedrich Fuhrmann, Hilchenbach (DE); Stephan Kramer, Hilchenbach (DE); Gunter Kneppe, Hilchenbach (DE)

Correspondence Address: Friedrich Kueffner, Suite 1921, 342 Madison Avenue, New York, NY, 10173, US

(21) Appl. No.: 10/002,991

(22) Filed: Nov. 15, 2001

Related U.S. Application Data
(62) Division of application No. 09/257,132, filed on Feb. 25, 1999.

(30) Foreign Application Priority Data
Sep. 17, 1996 (DE) 196 37 862.1

(51) Int. Cl. B26D 1/62

(52) U.S. Cl. 83/13; 83/305; 83/344; 83/345

(57) ABSTRACT

A flying shear with knife edges mounted on drums arranged opposite each other, wherein the knife edges can be accelerated to the feeding speed of the strip to be cut and the knife edges can be adjusted toward each other for carrying out a cut. The drums can be accelerated at least one drive unit to a circumferential speed which corresponds to the speed of the strip to be cut and a separately controllable adjusting device is provided for at least one of the drums. At least one of the drums is mounted on links which are connected to the adjusting devices; on the other hand, at least one of the drums may be mounted by means of at least one linear guide and the adjusting device acts on the guide members thereof.

### BACKGROUND OF THE INVENTION

1. Field of the Invention

The present invention relates to a high-speed shear for transversely cutting rolled strip. Specifically, the present invention relates to a flying shear with knife edges mounted on drums arranged opposite each other, wherein the knife edges can be accelerated to the feeding speed of the strip to be cut and the knife edges can be adjusted toward each other for carrying out a cut.

2. Description of the Related Art

In the manufacture of hot-rolled wide strip, the endless rolling method is used more and more. The material used is produced by welding preliminary strips or in casting machines. However, hot-rolled wide strip is also manufactured by using a semi-endless rolling method in which the material used may have the length of several-preliminary strips which may be stored intermediately on roller tables, roller-hearth furnaces or in coil boxes.

After the hot-rolling procedure, the finished strip must be cut to the strip lengths corresponding to the required coil weights. The cut should be carried out in continuous operation, i.e., at rolling speed. Accordingly, the cut must be carried out at the speeds of trains for hot-rolling wide strip which are conventional today in the range of 5 m/sec. to 30 m/sec., preferably 10 m/sec. to 20 m/sec. The strip thicknesses are between 0.5 mm to 30 mm, preferably between 0.6 mm to 1.5 mm.

Rotary shears or guillotine shears which are conventional in the art and serve to cut hot-rolled wide strip, are not designed for such high strip speeds. However, flying shears which are used following cold-rolling tandem trains operate only at strip speeds of about 6 m/sec.

### SUMMARY OF THE INVENTION

Therefore, it is the primary object of the present invention to further develop a flying shear for cutting hot-rolled wide strip in such a way that exact cuts can be carried out at strip speeds of up to 30 m/sec. and on strips having minimum strip thicknesses.

In accordance with the present invention, the drums can be accelerated by means of at least one drive unit to a circumferential speed which corresponds to the speed of the strip to be cut and a separately controllable adjusting device is provided for at least one of the drums.

At the high strip speeds mentioned above, it is no longer possible to economically carry out the conventional cutting procedures in which the knife drums are accelerated to strip speed for carrying out the cut and in which the knife drums must subsequently be decelerated again. Therefore, a significant feature of the present invention resides in controlling the acceleration of the knife drum to strip speed or the operation of the knife drums at strip speed separately from the cutting movement which is carried out perpendicularly to the strip.

It is possible early enough to accelerate the knife drum to its circumferential speed or to the circumferential speed of the knives corresponding to the strip speed or to rotate the knife drum continuously with a circumferential speed which corresponds to the strip speed, so that the drive unit for the knife drum can be small because the required acceleration forces are not substantial. The adjustment of the knife drum for carrying out the cut is effected through a separate system which, because it is a separate system, can also be of simpler construction than in the conventional cutting devices.

In accordance with an advantageous feature, at least one of the drums is mounted on links which are connected to the adjusting devices; on the other hand, at least one of the drums may be mounted by means of at least one linear guide and the adjusting device acts on the guide members thereof. The drums or the knives cutting the strip can rotate at strip speed and, as soon as a coil length corresponding to the desired coil weight has passed the shears, the links or the guide members of the linear guide can be adjusted to carry out the cut.

Various drives can be used for carrying out the adjustment. However, it has been found useful to construct the adjusting devices as eccentric adjusting devices or to provide pressure medium cylinders as adjusting devices.

An optimum cut is ensured if both drums arranged opposite each other are equipped with knives. The knife drums must be exactly synchronized. If one of the two drums is provided with an anvil, or if one of the two drums is equipped with a casing which is hardened in such a way that it can be used as an anvil, an area is created in which the strip can be cut and in which a less accurate synchronization of the two drums is sufficient.

It is important that the circumferential speed of the drums can be synchronized with respect to the feeding speed of the strip. The synchronization should be carried out in such a way that the circumferential speed of the cutting edges of the knives or the surface speed of the anvil or of the drum casing coincide with the feeding speed of the strip.

It is also important that the adjusting devices are synchronized, controlled and/or operated relative to the rotation of the drum in such a way that the adjusting movements are concluded when the knives pass through and the adjusting devices are moved back after the knives have passed through. Before the cut is to be carried out, the knives are accelerated sufficiently early to the feeding speed of the strip. For carrying out the cut, the knives merely have to be adjusted toward each other. The adjustment is carried out in such a way that the movement of the knives, or of the knife and the anvil or the drum casing, is concluded at the beginning of the cut and, after the cut has been effected, the drums are moved apart again before the drum has carried out another rotation and, thus, another cut.

The synchronization of the drums relative to each other or relative to the adjusting devices can be effected through appropriate gear systems or through electric or electronic means. The adjusting distance of the drums can be compensated by articulated spindles arranged between the gear systems or the appropriate drives and the drums.

In order to be able to vary the cuts, devices for axially displacing the drums are arranged parallel to the adjusting devices. The axial displacement of the drums can also be carried out during the cut.

If knives are used which have a predetermined curvature, specified shapes of the strip beginning can be obtained which help in reliably transporting the strip to the reeling unit.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a schematic illustration of a shear according to the present invention arranged in a train for hot-rolling wide strip, wherein one of the knife drums is guided in a linear guide means.

FIG. 2 is a schematic illustration, on a larger scale, of a shear according to the present invention with knife drums mounted on links;

FIG. 3 is a schematic illustration of a shear with knife drums mounted on links, wherein one of the drums is equipped with an anvil; and

FIG. 4 is a schematic illustration of a drive of the shear according to the present invention for achieving the mechanical synchronization of the shear.

### DETAILED DESCRIPTION OF THE PREFERRED EMBODIMENTS

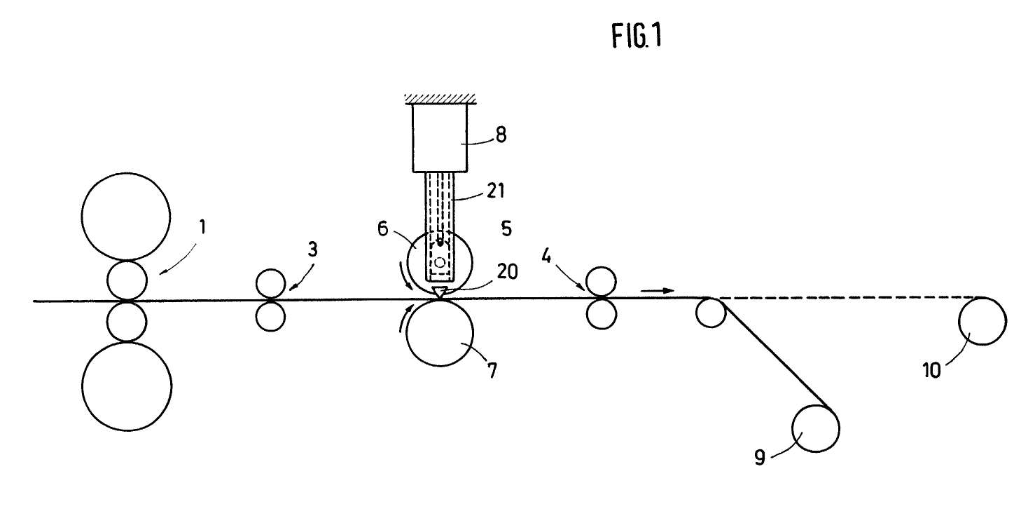

FIG. 1 of the drawing shows the last stand 7 of a train for hot-rolling wide strip in which the endless strip 2 is rolled to the desired dimensions. The rolling train is followed by a driver 3 and a shear 5 for cutting the endless strip 2 is provided between the driver 3 and another driver 4. The shear 5 is composed of drums 6, 7 whose circumferential speeds coincide with the strip speed. The strip speed is derived either from the rate of rotation of the driver 3 or from a pickup, not shown.

The drum 7 guided in linear guide means 21 can be adjusted by means of adjusting devices 8 separately from the rotary drive, not shown, of the drum 7. The drum 6 has a knife 20, while the drum 7 is provided with a specially hardened casing which acts as a counterknife. The strip is wound onto a reel 9. After the cut has been carried out, the strip beginning is conducted to the reel 10 and is wound onto the reel 10, while the finished coil can be removed from the reel 9.

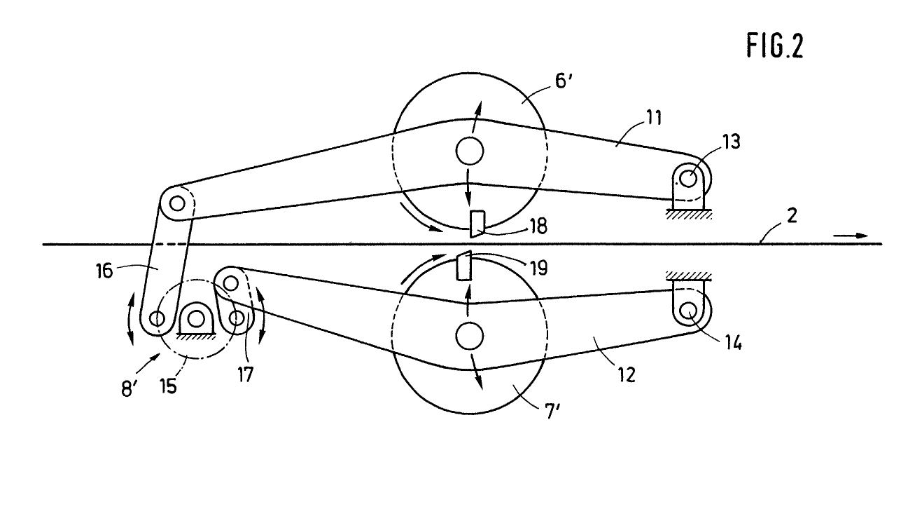

FIG. 2 of the drawing shows the strip 2 and drums 6′, 7′. The drums 6′, 7′ are mounted on links 11, 12, respectively. One end of each of the links is mounted in a fulcrum 13, 14. The adjusting device 8′ acts on the respectively other ends of the links 6′, 7′. The adjusting device 8′ is an eccentric drive whose eccentric adjusting member 15 is connected through connecting members 16, 17 in an articulated manner to the links 11, 12. Only a quarter rotation of the eccentric adjusting member 15 is required for moving the free ends of the links 11, 12 toward each other and to cause the drums 6′, 7′ to carry out the cut.

Knives 18, 19 are mounted on the drums 6′, 7′. Devices, not shown, are provided for synchronizing the drums 6′, 7′ mechanically or electrically or electronically, so that the knives 18, 19 are moved to carry out the cut in such a way that a gap remains between the knives.

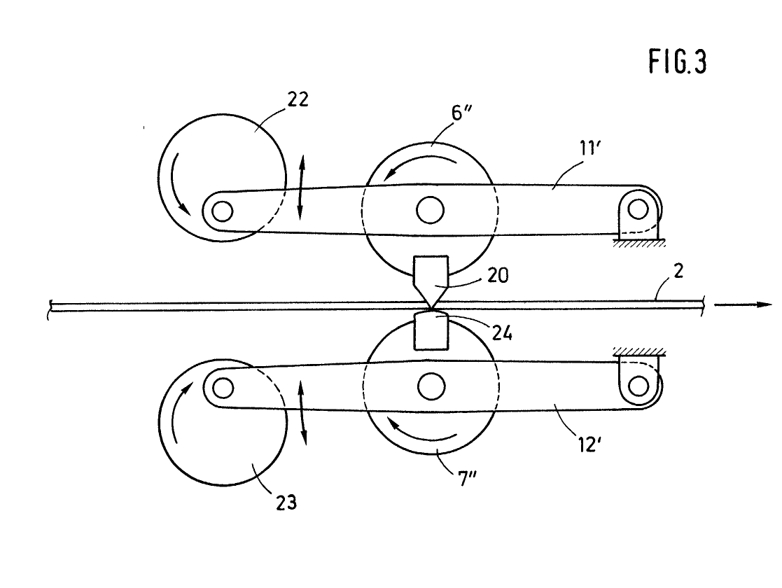

FIG. 3 of the drawing shows links 11′, 12′ which support the drums 6″, 7″. The free ends of the links 11′, 12′ are connected to eccentric adjusting members 22, 23, wherein the drives, not shown, of the eccentric adjusting members 22, 23 can be synchronized relative to each other and relative to the drums 6″, 7″. Instead of the eccentric adjusting members 22, 23, any other adjusting devices 8, for example, piston/cylinder units, can be provided.

A knife 20 is arranged on the drum 6′, while an anvil 24 is mounted on the drum 7″. In this case, the synchronization between the drums 6″ and 7″ does not have to be as exact as, for example, in the case of the drums 6′, 7′ according to FIG. 2, because the anvil 2 provides a large cutting area for the knife 20.

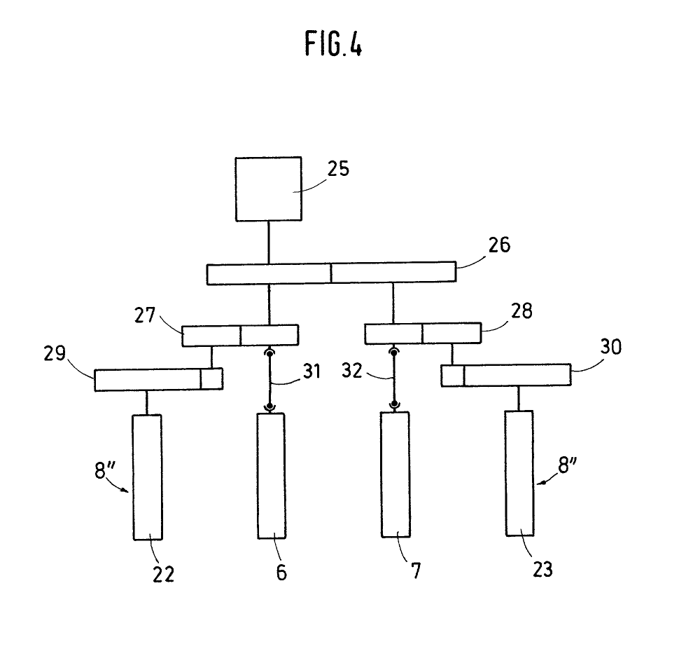

FIG. 4 of the drawing shows a drive unit 25 which is connected to a principal grooved roller gear unit 26. The principal grooved roller gear unit 26 acts on a grooved roller gear unit 27 for the drum 6 and on a grooved roller gear unit 28 for the drum 7. The adjusting force for the eccentric adjusting member 22 is derived from the grooved roller gear unit through a gear unit 29, while the adjusting force for the eccentric adjusting member 23 is transmitted from the grooved roller gear unit 28 through a gear unit 30.

The drums 6, 7 are mechanically synchronized relative to each other through the gear units 26, 27, 28. Moreover, a synchronization is provided through the gear units 26 to 30 between the eccentric adjusting members 22, 23, on the one hand, and between the drums 6, 7, on the other hand. For example, if only one eccentric adjusting member 22 is used, the gear units 28 and 30 can be omitted. The drums 6, 7 are driven through universal joint shafts 31, 32 which are capable of compensating the movement between the stationary gear units 26 to 28 and the drums 6, 7 which are moveable toward each other. However, a synchronization of the drums and the adjusting devices in an electric or electronic manner or in a hydraulic manner, which is also a feature of the present invention, is not illustrated in the drawing.

The shear according the present invention is used for dividing an endless hot strip travelling at high speed into lengths which correspond to the desired coil weights. At speeds of the hot-rolled wide strip of up to 30 m/sec. and strip thicknesses as low as 0.5 mm, the endless strips can no longer be securely introduced or threaded into the trains for hot-rolling wide strip. For this reason, the stands are adjusted, for example, to a gap of about 1.5 mm and the strip beginning is rolled with this adjustment until the appropriate tension can be produced by the winding reel. The stands of the train can then be adjusted to 0.5 mm. As soon as the first strip portions with the desired final thickness have passed the shear, the shear is adjusted to carry out the cut. Similarly, before the end of the strip enters the rolling train, the roll gap is again adjusted to about 1.5 mm and the shear is adjusted to carry out the cut before the strip which has now a greater thickness passes the shear.

The cutting system disclosed herein for use in connection with hot-rolled strip can analogously also be used in connection with cold strip leaving cold-rolling trains.

The invention is not limited by the embodiments described above which are presented as examples only but can be modified in various ways within the scope of protection defined by the appended patent claims.

We claim:

1. A flying shear for cutting rolled strip travelling at a feeding speed, the shear comprising knife edges mounted on oppositely arranged drums, at least one drive unit for accelerating the oppositely arranged drums to a circumferential speed corresponding to the feeding speed of the strip, and an adjusting device for adjusting at least one of the drums, wherein the adjusting device is controllable separately of the drive unit.

2. The flying shear according to claim 1, wherein at least one the drums is mounted on a link connected to the adjusting device.

3. The flying shear according to claim 1, wherein at least one of the drums is mounted on a linear guide means comprising guide members, wherein the adjusting device is operatively connected to the guide members.

4. The flying shear according to claim 1, wherein the at least one adjusting device is an eccentric adjusting means comprising eccentric adjusting members.

5. The flying shear according to claim 1, wherein the at least one adjusting device comprises pressure medium cylinders.

6. The flying shear according to claim 1, wherein each of the oppositely arranged drums comprises a knife edge.

7. The flying shear according to claim 1, wherein one of the drums has a knife edge and a second of the drums has an anvil configured to cooperate with the knife edge.

8. The flying shear according to claim 7, wherein one of the drums is equipped with a knife edge and a second of the drums has a casing area acting as an anvil and configured to cooperate with the knife edge.

9. The flying shear according to claim 1, comprising means for synchronizing the circumferential speed of the drums to the feeding speed of the strip.

10. The flying shear according to claim 1, comprising means for synchronizing the drums so as to maintain a cutting gap between the knife edges.

11. The flying shear according to claim 1, further comprising means for at least one of synchronizing, controlling and operating the adjusting device relative to a rotation of the drums such that an adjusting movement of the knives is concluded when the knives carry out a cut and the knives are moved back after the cut has been carried out.

12. The flying shear according to claim 1, comprising a gear mechanism for synchronizing the adjusting device relative to the drive unit.

13. The flying shear according to claim 1, comprising an electric or electronic synchronization means for synchronizing the adjusting device relative to the drive unit.

14. The flying shear according to claim 1, comprising universal joint shafts connected to the drums for compensating an adjusting distance of the drums.

15. The flying shear according to claim 1, further comprising means for axially displacing the drums, the means for axial displacement being arranged parallel of the adjusting device.

16. The flying shear according to claim 1, wherein the knife edges are curved.

17. In a method of operating a flying shear for cutting strip, wherein the flying shear includes knife edges mounted on oppositely arranged drums, wherein the knife edges can be accelerated to a feeding speed of the strip and can be adjusted relative to each other for carrying out a cut, the improvement comprising accelerating the knife edges to a circumferential speed corresponding to the feeding speed of the strip and carrying out an adjusting movement of the knife edges independently of the rotary movement of the knife edges.
